(19) United States
(12) Patent Application Publication
(10) Pub. No.: US 2026/0019304 A1
(43) Pub. Date: Jan. 15, 2026

(54) Systems and Methods for Providing Wireless Connectivity to HVAC Systems via a Mesh Network

(71) Applicant: Rheem Manufacturing Company, Atlanta, GA (US)

(72) Inventors: Kerlin Pravinna David Robert, Van Buren, AR (US); Patrick Lai Figueroa, Indianapolis, IN (US); Raheel Ashraf Chaudhry, Frisco, TX (US)

(21) Appl. No.: 19/262,631

(22) Filed: Jul. 8, 2025

Related U.S. Application Data
(60) Provisional application No. 63/669,514, filed on Jul. 10, 2024.

(51) Int. Cl. H04L 12/66; H04L 41/12; H04L 67/12; H04L 69/18

(52) U.S. Cl. CPC H04L 12/66; H04L 41/12; H04L 67/12; H04L 69/18

(57) ABSTRACT

The present disclosure is directed to systems and methods for providing wireless connectivity to HVAC systems via a mesh network. Particularly, a connectivity architecture is provided that forms a seamless wireless mesh network of connected HVAC systems. For example, HVAC systems may be in communication with a plurality of DTUs that form the mesh network. The DTUs communicate with the HVAC systems and also communicate with remote devices. A dedicated gateway device may also be provided in the mesh network to communicate with the remote devices. This architecture allows a user to remotely interact with such systems via a remote device (for example to view status information for the systems, provide commands to adjust the operation of the systems, etc.). Likewise, a building management system (BMS) (or other type of automated system) may wirelessly communicate with such systems to perform similar functions, but in an automated manner.

### CROSS-REFERENCE TO RELATED APPLICATIONS

This application claims priority to and benefit of U.S. provisional patent application No. 63/669,514 filed Jul. 10, 2024, which is herein incorporated by reference.

### TECHNICAL FIELD

The present disclosure is generally in the field of communication systems for providing wireless connectivity to vapor compression cycle systems.

### BACKGROUND

Typically, remotely viewing information about heating, ventilation, and air conditioning (HVAC) systems (and other types of similar systems, such as systems including water heaters), as well as controlling operations of such systems, is limited to the thermostat level. That is, a user can view information about the system as a whole (e.g., similar types of information that may be viewed on the thermostat) and can control the operation of the units via the thermostat, however, the user is not able to directly view information about and control individual units within the system. Additionally, in some cases, HVAC systems may include non-communicating units that are incapable of performing wireless communications to transmit and/or receive data.

These limitations of existing systems are further complicated in commercial or large-scale residential settings, including settings that use building management systems (BMS). In such systems, standards exist (e.g., BACnet, etc.) for communications between the units in the system but require individual connections between the BMS and the individual units in the system, which complicates installation and the system.

The foregoing background information is provided to reveal information believed by the applicant to be of possible relevance to the present disclosure. No admission is necessarily intended, nor should be construed, that any of the preceding information constitutes prior art against the present disclosure.

### BRIEF DESCRIPTION OF THE DRAWINGS

FIGS. 1A-1B illustrate systems for providing wireless connectivity to vapor compression cycle systems, in accordance with one or more embodiments of the disclosure.

FIG. 2 illustrates another system for providing wireless connectivity to vapor compression cycle systems, in accordance with one or more embodiments of the disclosure.

FIG. 3 illustrates another system for providing wireless connectivity to water heaters, in accordance with one or more embodiments of the disclosure.

FIGS. 4A-4C illustrate some example components that may be included in the connectivity device of the system of FIG. 3, in accordance with one or more embodiments of the disclosure.

FIG. 5 illustrates a method for providing wireless connectivity to vapor compression cycle systems, in accordance with one or more embodiments of the disclosure.

FIG. 6 illustrates a computing device, in accordance with one or more embodiments of the disclosure.

### DETAILED DESCRIPTION

The present disclosure is directed to systems and methods for providing wireless connectivity to vapor compression cycle systems via a mesh network. Particularly, a connectivity architecture is provided that forms a seamless wireless mesh network of connected vapor compression cycle systems. This architecture allows a user to remotely interact with such systems (for example, to view status information for the systems, provide commands to adjust the operation of the systems, etc.). Likewise, a building management system (BMS) (or other type of automated system) may wirelessly communicate with such systems to perform similar functions, but in an automated manner. The connectivity architecture improves over existing systems by allowing for remote control of vapor compression cycle and other such units at the unit (equipment) level (for example, viewing information about individual units and providing commands to control the operation of individual units). This connectivity architecture is advantageous in applications involving a large number of units, such as a hotel, apartment building, multi-family home, etc., but may also be applicable in smaller-scale applications (such as single-family residential homes) as well.

A “vapor compression system” may broadly encompass any system that is configured to heat and/or cool a conditioned space, heat and/or cool a fluid that is provided to a load, and/or perform any other actions associated with a vapor compression cycle. Non-limiting examples of types of vapor compression systems can include air conditioners (e.g., no reversing valve, only provides cooling mode), heat pumps (e.g., air source or geothermal; has a reversing valve and operates in both heating and cooling modes), heat pump water heaters, integrated heat pump water heaters, split system heat pump water heaters, heat pump water heaters with a circulation pump and a brazed plate heat exchanger, split systems, packaged systems, mini-splits, PTACs, window units, vertical packaged systems, VRF systems, etc.

For example, a vapor compression system may generally include components that combine to form a refrigerant loop that is used to produce conditioned air that is circulated throughout the conditioned space by the vapor compression system. For example, the refrigerant loop may include an indoor heat exchanger coil, an outdoor heat exchanger coil, a compressor, and an expansion valve (however, these components may vary, depending on the specific vapor compression system).

Continuing this example, during the operation of this exemplary vapor compression system in a cooling mode, warm indoor air is pulled (or pushed) over the indoor heat exchanger coil (which may be the evaporator coil of the vapor compression system) by a fan of the vapor compression system. As the liquid refrigerant inside the indoor heat exchanger coil converts to gas, heat is absorbed from the indoor air into the refrigerant, thus cooling the air that is pulled over the indoor heat exchanger coil. The fan is then operated to pull the cooled air into a conditioned space (such as a residential home or commercial establishment) that is being cooled by the air conditioning system. In some instances, this cooled air may be distributed throughout the conditioned space using ductwork installed within the conditioned space. The refrigerant gas then passes into the compressor. The compressor pressurizes the refrigerant gas and sends the refrigerant into the outdoor heat exchanger coil, which may operate as a condenser coil. A fan pulls outdoor air through the outdoor heat exchanger coil, allowing the air to absorb heating energy from the home and release it outside. During this process, the refrigerant is converted back to a liquid. The refrigerant then travels back to the indoor heat exchanger coil. The refrigerant passes through an expansion valve, which regulates the flow of refrigerant into the indoor heat exchanger coil. The cold refrigerant then absorbs more heat from the indoor air and the cycle repeats.

Likewise, in a standard heating mode, a reversing valve may be transitioned to direct refrigerant from the compressor to the indoor heat exchanger coil as opposed to directing it to the outdoor heat exchanger coil, as is done in the cooling mode. In a heating mode, the refrigerant absorbs heat from the outdoor air through the outdoor heat exchanger coil. The refrigerant then passes through the compressor, which compresses (and thus warms) the refrigerant. The heated refrigerant is transferred to the indoor heat exchanger coil. One or more fans push or pull air over the indoor heat exchanger coil, thereby transferring heat from the indoor heat exchanger coil to the conditioned space. Ductwork then directs the conditioned air throughout the conditioned space to heat the conditioned space. One or more supplemental heating sources, such as an electric heating kit, and/or a gas furnace with a heat exchanger in the indoor coil portion, may additionally be used. This description is merely exemplary and the specific operation of the vapor compression system may vary depending on the specific vapor compression system.

For consistency's sake, reference is made hereinafter to HVAC units, HVAC systems, or the like as an exemplary use case of the mesh network as described herein. However, this is not intended to be limiting and any other type of vapor compression cycle system may be applicable.

In embodiments, the architecture includes multiple data transfer units (DTUs) that serve as intermediary devices between the individual HVAC units and any remote devices (for example, a user device (such as a smartphone, desktop or laptop computer, tablet, etc.), a BMS, etc.). As used herein, the term “remote device” generally refers to a device that is separate from the HVAC units and does not necessarily need to be located physically outside of the building in which the HVAC units are located. For example, a “remote device” may also include a device that is physically proximate and performs communications over a short-range communication protocol (e.g., Bluetooth, etc.). A remote device may also include a device that is not physically proximate and performs communications over a long-range communication protocol. These DTUs may include, as non-limiting examples, RS485 Econet and BACnet MS/TP and/or Modbus remote termination unit (RTU) capabilities (or any other suitable communication protocols) that allow the DTUs to directly communicate with the HVAC units to retrieve data from the units and provide control instructions. For example, a DTU may be provided for each of the overall HVAC systems (a “HVAC system” as described herein may refer to a collection of individual HVAC units) and may be responsible for managing communications with that HVAC system. However, this configuration is not intended to be limiting and DTUs may also be provided for individual HVAC units that form an HVAC system and/or any DTU may manage data transmissions to and from multiple HVAC systems.

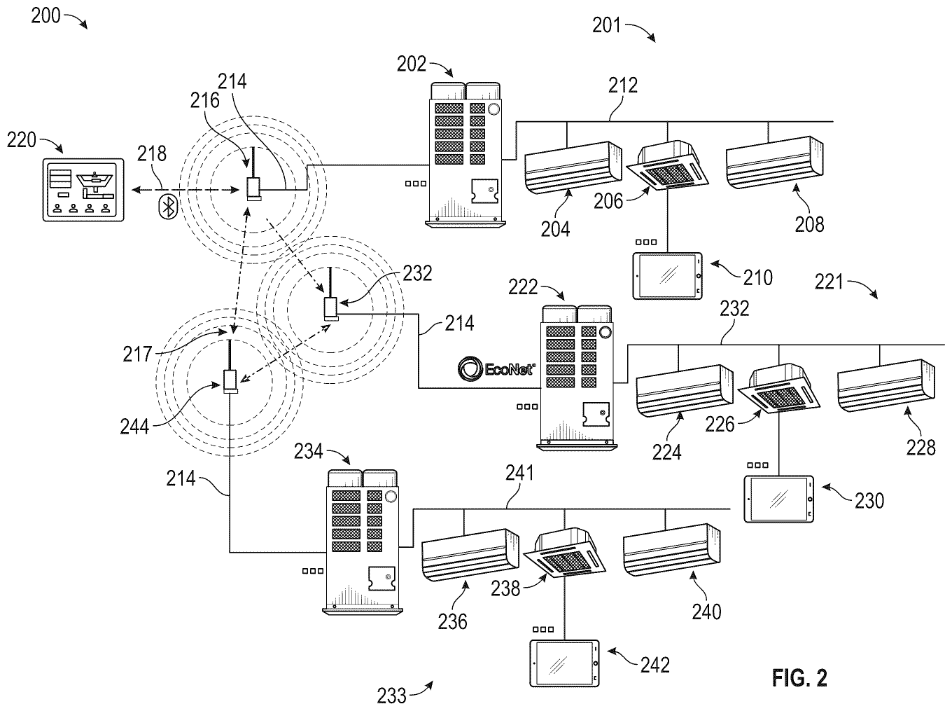

In addition to the DTUs managing communications with the HVAC systems, the DTUs themselves form a mesh network and communicate within the mesh network using a wireless mesh network protocol, such as Thread (or any other mesh network protocol). In some embodiments, a dedicated gateway device may also be included in the mesh network (for example, illustrated in systems 100, 150, 300, etc.). In such embodiments, the gateway device may be responsible for routing any communications from the DTUs to the remote devices. The gateway device may be responsible for managing routing of communications through the mesh network and to any remote devices. The gateway device may either route communications in parallel to multiple DTUs or serially through one DTU at a time. However, the mesh network may not necessarily always include a dedicated gateway device. In such scenarios, one or more of the DTUs may communicate directly with the remote devices (for example, as shown in system 200 of FIG. 2).

The communications performed between the various devices included within this architecture may be based on different communication protocols. For example, the communications between the HVAC systems and the DTUs may be performed using a first type of communication protocol, such as EcoNet or BACnet (or any other type of communication protocol). In some instances, different HVAC systems may communicate with their respective DTUs using different communication protocols, even within the same building. For example, a first HVAC system may communicate with a first DTU using the EcoNet protocol and a second HVAC system may communicate with a second DTU using the BACnet protocol. Further, as aforementioned, the DTUs may communicate with one another within the mesh network using yet another communication protocol (a mesh network communication protocol such as Thread).

Given that different communication protocols are used for communications between the HVAC systems and the DTUs and for communications between the DTUs, the DTUs are configured to translate messages between any two communication protocols that may be used. That is, each DTU may be configured to identify the particular communication protocol that is being used by an HVAC system communicating with the DTU (or an indication of the communication protocol may be pre-determined and provided to the DTU) and translate the message into a wireless mesh network communication protocol such that the message may then be transmitted within the mesh network. This may be accomplished in any suitable manner. As one non-limiting example, each DTU may maintain (or otherwise have access to) a look-up table that may be referenced by the DTU to automatically perform such translations.

Some systems may also include at least one non-communicating unit. A non-communicating unit may not have electronic communication capabilities and thus may not be able to communicate data to other units in the HVAC system. Instead, the non-communicating unit may simply be instructed to turn on or off. For example, a circuit electrically coupled to the non-communicating unit may be completed, e.g., via a command signal transmitted by a thermostat, such that voltage may be transmitted to the non-communicating unit to power on. Moreover, the circuit may be broken to cease delivery of voltage to thereby power off the non-communicating unit. In some digital systems, the command signals may further include a temperature set point along with the on/off command. For example, the indoor unit may send a command signal to the outdoor unit instructing the outdoor unit to turn on and to operate in a manner to achieve a predetermined temperature, such as by providing air conditioning to a certain temperature, etc.

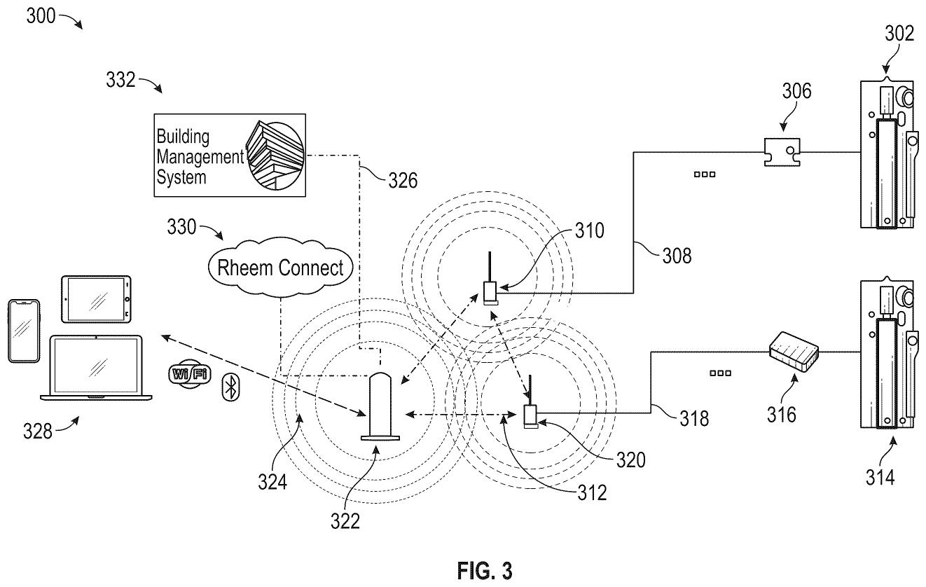

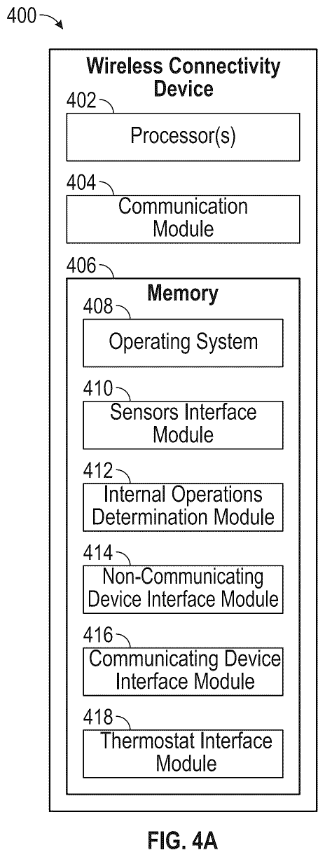

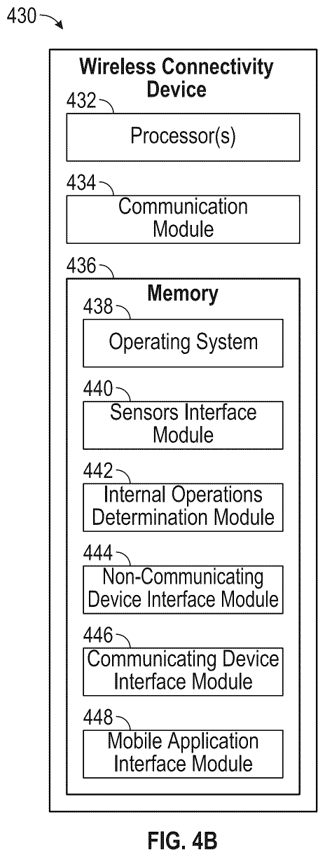

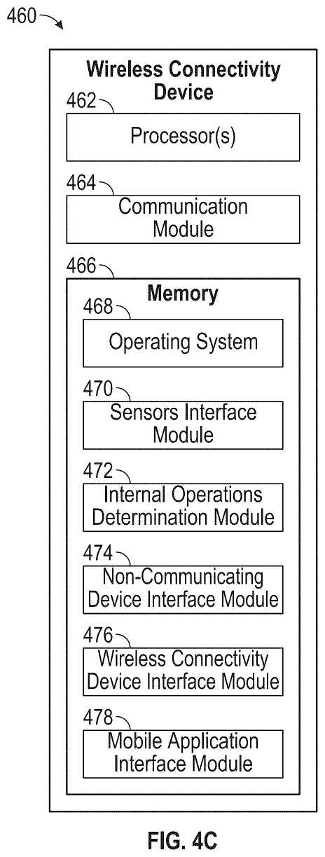

To allow for communications to be performed between the DTUs within the mesh network and such non-communicating units, a connectivity device may be mechanically and operatively coupled to or otherwise integrated with the non-communicating unit, to thereby provide communication capabilities to the non-communicating unit. Beyond simply providing basic communication to the non-communicating unit, the connectivity device (which may be wired or wireless) may further be used to determine or monitor system operation and diagnostic services. An example of an architecture including these connectivity devices is shown in FIG. 3. Further details about exemplary connectivity devices are provided with respect to FIGS. 4A-4C.

While reference is made herein to HVAC systems, similar wireless connectivity may also be provided to systems that include other types of units, such as water heaters, for example. These systems and methods described herein may also be applicable to any other type of appliance as well. The term “appliance” may be used to generally refer to any HVAC unit, water heater, residential appliance (refrigerator, washing machine, etc.), commercial appliance, etc.

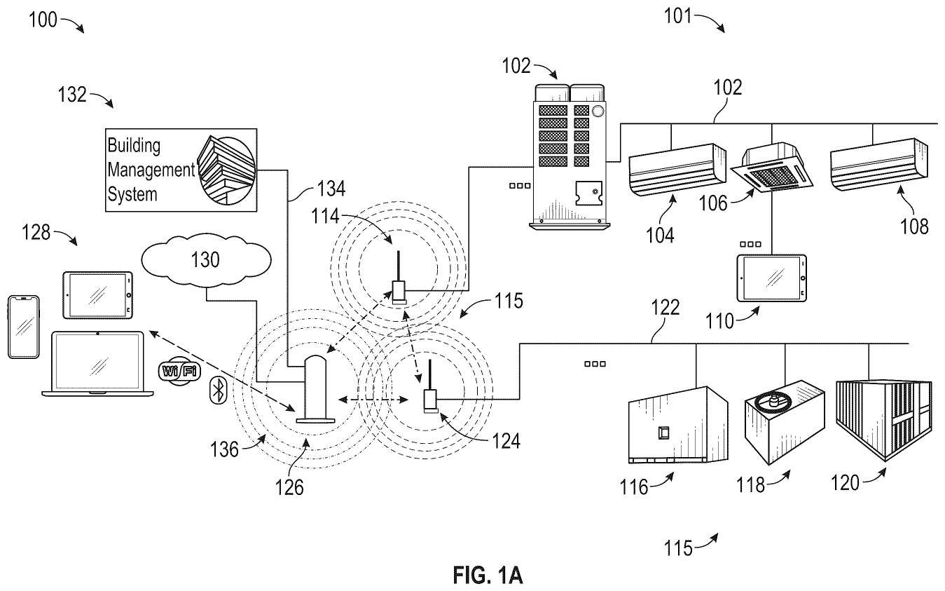

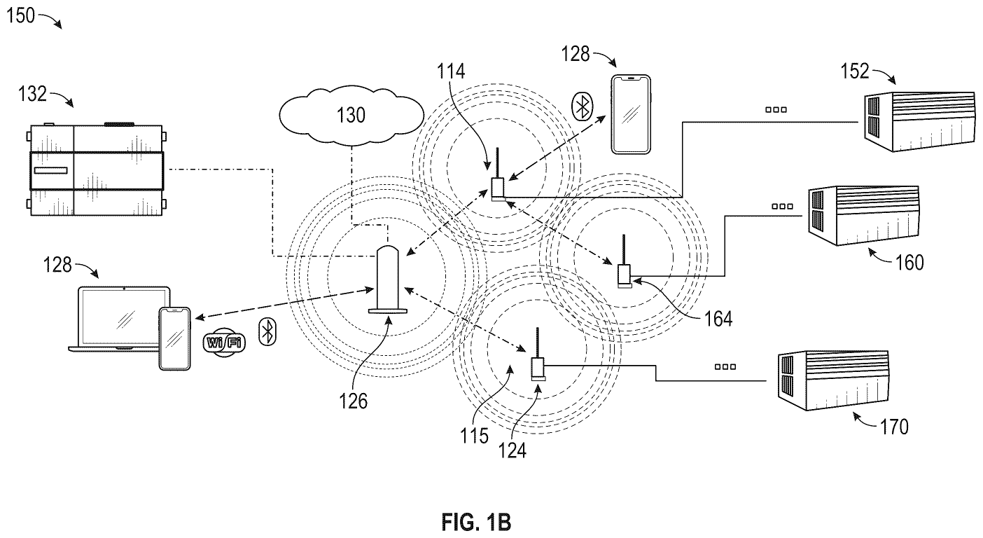

Referring now to FIG. 1A, a first exemplary system 100 for providing wireless connectivity to HVAC systems is shown. The system 100 represents a first use case of the system for providing wireless connectivity to HVAC systems. Particularly, the system 100 involves a use case in which HVAC systems with existing connectivity capabilities are connected to a gateway device 126.

FIG. 1A shows a first HVAC system 101 including a first HVAC unit 102, second HVAC unit 104, third HVAC unit 106, a fourth HVAC unit 108, and a thermostat 110. For example, the first HVAC system 101 may be a variable refrigerant flow (VRF) system.

FIG. 1A also shows a second HVAC system 115 including a fifth HVAC unit 116, sixth HVAC unit 118, and seventh HVAC unit 120, and a thermostat 110. For example, the fifth HVAC unit 116, sixth HVAC unit 118, and seventh HVAC unit 120 are shown as being commercial air conditioning units.

The HVAC systems shown in FIG. 1A are merely exemplary configurations of HVAC system and the HVAC systems 101 and 115 may also include any other number and/or combination of different types of units. Additionally, the number of HVAC systems shown in FIG. 1A is merely exemplary and any other number of HVAC systems may also be provided. These statements may also be applicable to any other HVAC system described herein (for example, systems 150, 200, and 300, etc.). Further, as aforementioned, while reference is made to HVAC units, other types of units may also be included in the systems (such as water heaters, as one non-limiting example).

Each of the first HVAC system 101 and the second HVAC system 115 may include respective local communication networks through which data communications and/or other types of signals may be transmitted between the various units of the systems. For example, the units of the first HVAC system 101 may communicate using a wired network connection 102 using the EcoNet communication protocol via serial connections. The units of the second HVAC system 115 may also communicate using a wired network connection 122, however, these units may perform communications via the BACnet communication protocol instead of the EcoNet protocol. These are merely examples of different types of communication protocols that may be used for communications performed between units of an HVAC system, and any other communications protocols may also be used. Additionally, the units may also be configured to perform wireless communications and/or may perform wired communications using any other type of connection interfaces (the communications are not necessarily limited to the use of RS485 serial connections).

To provide connectivity between external devices and the HVAC systems, each of the HVAC systems be provided with wired and/or wireless connectivity with a respective DTU. For example, FIG. 1A shows that the first HVAC system 101 is connected to a first DTU 114 via another RS485 serial connection and may communicate with the first DTU 114 using the EcoNet protocol. The second HVAC system 115 is connected to a second DTU 124 via another RS485 serial connection and may communicate with the second DTU 124 using the BACnet protocol. However, any other types of communication interfaces and any other types of protocols may also be used for communications between the HVAC systems and their respective DTUs.

While the system 100 (as well as other systems described herein) shows a DTU managing communications for each HVAC system, this is not intended to be limiting. For example, the first DTU 114 (or the second DTU 124) may manage communications for both the first HVAC system 101 and the second HVAC system 115 as well.

This remote connectivity may allow for a user to view status information (for example, information obtained from any sensors of the units, as well as any other types of relevant information) at the individual unit level for any of the units in the HVAC systems 101 and 115 and may also allow for the user to remotely control operation of any of the HVAC units. For example, the data may be transmitted to a user device, such as a smartphone, laptop or desktop computer, or the like. The remote connectivity may also provide similar functionality for an automated system, such as a BMS. Such an automated system may receive the same types of data and may transmit automated control instructions to the units based on the data.

The first DTU 114 and second DTU 124 form a mesh network 115 with a dedicated gateway device 126 (along with any other number of DTUs that may be included in system 100). Communications within the mesh network 115 may be performed using another communication protocol such as Thread or any other mesh network communication protocol.

The mesh network 115 created between the DTUs and the gateway 126 minimizes any issues that may otherwise arise due to a single point of failure (that is, if one of the DTUs in the mesh network 115 experiences an issue and is temporarily unable to perform communications, then the other DTUs in the mesh network may still be able to transmit data in place of the unavailable DTU). For example, the mesh network may detect when one DTU becomes unavailable and another DTU may begin receiving communications from the system that was previously in communication with the now unavailable DTU. Even if another DTU is unable to take over communications for the unavailable DTU, only one DTU in the mesh network is unavailable and the remaining DTUs may still communicate with their respective systems. The term “separate” device may also be used in place of “remote” device in some instances herein.

The mesh network 115 also extends the communication range of units and devices included in the network as more DTUs are integrated into the mesh network 115. For example, some or all of the DTUs may serve as wireless or wired repeaters such that a first DTU that is out of range of a second DTU (or another device) may still transmit communications to the second DTU through a third DTU that is closer in distance to the first DTU.

Given that the communication protocol used to perform communications over the mesh network 115 may be different than the communication protocols used for communications between the HVAC systems and the DTUs, the DTUs may be configured to translate messages from one communication protocol to another communication protocol (for example, translate a message from an EcoNet protocol to a Thread protocol (or any other mesh network protocol) and/or any other type of translations between any other two communication protocols. This translation may be performed, for example, by using a look-up table, however, the translations may also be performed in any other suitable manner.

Within the mesh network 115, any communications received by a DTU from an HVAC system may be transmitted to the gateway device 126 and the gateway device 126 may then transmit the communications to any number of different remote devices. For example, as shown in FIG. 1A, the gateway device 126 may transmit the communications to one or more user devices 128, one or more cloud devices 130 (for example, a remote server), a BMS 132, and/or any other type of remote device.

Any of the remote devices may present information about the individual HVAC units of the HVAC systems 101 and 115 to a user. The user may also provide control instructions to individual HVAC units of the first and second HVAC systems 101 and 115 using the remote devices. In some instances, the remote devices may automatically provide control instructions based on the information received from the first and second HVAC systems 101 and 115 and/or the individual HVAC units.

The communications that are transmitted to the remote devices may also be transmitted using different communication protocols than the communication protocols used within the mesh network 115 and the communication protocols used between the HVAC systems and the DTUs. For example, FIG. 1A shows that the user devices 128 communicate with the gateway device 126 using Wi-Fi or Bluetooth communications, the cloud device 130 communicates with the gateway device 126 using Ethernet, and the BMS 132 communicates with the gateway device 126 using a BACnet communication protocol. These are merely exemplary communication protocols and any other communication protocols may be used. Accordingly, similar to the DTUs, the gateway device 126 may also be configured to perform translations between different types of communication protocols. Such communications may also be performed using a look-up table or using any other suitable method.

Referring now to FIG. 1B, a second example of a system 150 for providing wireless connectivity to HVAC systems is shown. The system 150 includes a similar architecture as the system 100 of FIG. 1A. The system 150 of FIG. 1B shows a specific use case in which individual HVAC units (for example, HVAC unit 152, HVAC unit 160, HVAC unit 170, etc.) of a multi-family building communicate with the mesh network via first DTU 114, second DTU 164, and third DTU 124. In the example shown in FIG. 1B, the HVAC units may be packaged terminal air conditioners (PTAC), however, as aforementioned, any other types of HVAC units or other types of units (e.g., water heaters) may also be used.

Referring now to FIG. 2, a third example of a system 200 for providing wireless connectivity to HVAC systems is shown. The system 200 represents a third use case of the system for providing wireless connectivity to HVAC systems. Particularly, the system 200 involves a use case in which HVAC systems with existing connectivity capabilities are connected to a separate device or devices without the use of a dedicated gateway device.

FIG. 2 shows a first HVAC system 201 including a first HVAC unit 202, second HVAC unit 204, third HVAC unit 206, a fourth HVAC unit 208, and a first thermostat 210. For example, the first HVAC system may also be a VRF system similar to the HVAC system 101 of FIGS. 1A-1B. Similarly, the system 200 is shown as including a second HVAC system 221 including a fifth HVAC unit 222, a sixth HVAC unit 224, a seventh HVAC unit 226, an eighth HVAC unit 228, and a second thermostat 320, as well as a third HVAC system 233 including a ninth HVAC unit 222, a tenth HVAC unit 224, an eleventh HVAC unit 226, a twelfth HVAC unit 228, and a third thermostat 320. As aforementioned, the number of systems, types of systems, numbers of units in each system, and types of units in each system are merely exemplary.

Each of the first HVAC system 201, second HVAC system 221, and third HVAC system 233 may include respective local communication networks. For example, the units of the first HVAC system 201 may communicate through a wired network connection 212 using the Econet communication protocol using RS485 serial connections. A similar communication protocol is shown as being used for the wired network connection 232 of the second HVAC system 221 and the wired network connection 241 of the third HVAC system 233. The units may also be configured to perform wireless communications and/or may perform wired communications using any other type of connection interfaces (beyond RS485 serial connections).

Similar to the systems 100 and 150 of FIGS. 1A-1B, to provide connectivity between external devices and the HVAC systems, each of the HVAC systems may be provided with wired and/or wireless connectivity with a data transfer unit (DTU). For example, FIG. 2 shows that the first HVAC system 201 is connected to a first DTU 216 via another RS485 serial connection and may communicate with the first DTU 216 using the EcoNet protocol. The second HVAC system 221 is connected to a second DTU 232 via another RS485 serial connection and may communicate with the second DTU 232 using the EcoNet protocol. The third HVAC system 233 is connected to a third DTU 244 via another RS485 serial connection and may communicate with the second DTU 244 using the EcoNet protocol. However, any other types of communication interfaces and any other types of protocols may also be used for communications between the HVAC systems and their respective DTUs.

The first DTU 216, second DTU 232, and third DTU 244 may form a mesh network 217 (along with any other number of DTUs). Communications may be performed using a communication protocol suitable for mesh networks, such as the Thread protocol (or any other mesh network protocol). In contrast with the mesh network 115 of FIGS. 1A-1B, the mesh network 217 of FIG. 2 does not include a dedicated gateway device.

Given that the mesh network 217 does not include the dedicated gateway device, any data that is communicated to the DTUs by the HVAC systems may be sent to separate devices directly by the DTUs. For example, FIG. 2 shows a user device 220 performing communications with the first DTU 214 using a short-range wireless communication protocol (in this example, the wireless communication protocol is shown as being Bluetooth, however, any other types of wireless communications may also be performed). The user device 220 may be connected with the first DTU 214 to perform communications with the first DTU 214 through a Bluetooth synchronization process between the user device 220 and the first DTU 214. The user device 220 may also connect to any of the DTUs in any other manner. For example, the user device 220 may automatically connect to the physically closest DTU, which may be identified using any known technique, such as received signal strength indicators (RSSI).

Similar to the system 100 of FIG. 1, the DTUs shown in the system 200 of FIG. 2 may be configured to translate messages from one communication protocol to another communication protocol (for example, translate a message from an EcoNet protocol to a Thread protocol (or any other mesh network protocol) and/or any other type of translations between any other two communication protocols. This translation may be performed, for example, by using a look-up table, however, the translations may also be performed in any other suitable manner.

The system 200 allows a user to access the information being shared via the mesh network 217 (information obtained from the HVAC systems 201, 221, 233, etc.) via an application of the user device 220 to view information about the individual HVAC units and provide control instructions to the individual HVAC units or the HVAC systems as a whole. This architecture with the mesh network 217 without the dedicated gateway device may be advantageous in applications where it is undesirable to install and manage BMS and other remote monitoring systems. Any other instructions may also be provided, such as instructions for performing the initialization of a unit.

Referring now to FIG. 3, a fourth example of a system 300 for providing wireless connectivity to systems is shown. Particularly, the system 300 illustrates a third use case for providing wireless connectivity in which the units are non-communicating units (in this use case, the units are shown as being water heaters instead of HVAC units, however, HVAC units may also be applicable) that do not have connectivity capabilities (for example, lack the capability to transmit status data to remote devices). To address the communication deficits, one or more connectivity devices may be mechanically and operatively coupled to or otherwise integrated with the water heater units. The connectivity devices provide communication capabilities to the non-communicating water heater units such that data may then be communicated from the non-communicating water heater units to remote devices.

FIG. 3 shows a first water heater unit 302 and a second water heater unit 314. The first water heater unit 302 and the second water heater 314 may be non-communicating units that are not equipped with communication capabilities (that is the units may be hardwired into a thermostat or other type of controller and may be controlled using electrical signals transmitted via the hardwired connection).

To provide connectivity between external devices and the water heater units, each of the water heater units may be provided with wired and/or wireless connectivity with a data transfer unit (DTU). For example, FIG. 3 shows that the first water heater unit 302 is connected to a first DTU 310 via another RS485 serial connection and may communicate with the first DTU 310 using the EcoNet protocol. The second water heater unit 314 is connected to a second DTU 320 via another RS485 serial connection and may communicate with the second DTU 232 using the ModBus protocol. However, any other types of communication interfaces and any other types of protocols may also be used for communications between the water heater units and their respective DTUs.

Given that the first water heater unit 302 and the second water heater unit 314 are non-communicating units, connectivity devices may be provided for each of the water heater units to facilitate communications between the water heater unit and its respective DTU. For example, the water heater unit 302 may include a first connectivity device 306 and the second water heater unit 314 may include a second connectivity device 316. These may be separate devices that are installed at and/or within the water heater units. These connectivity devices allow for provide the capability to obtain status information from the water heater units. Further details about these connectivity devices are provided with respect to FIGS. 4A-4C.

The first DTU 310 and second DTU 320 may form a mesh network 312 with a gateway device 322 (along with any other number of DTUs that may be included in the mesh network 312). Communications within the mesh network 312 may be performed using a communication protocol suitable for mesh networks, such as Thread protocol (or any other mesh network protocol). The mesh network 312 created between the DTUs and the gateway minimizes any issues due to a single point of failure. The mesh network 312 also extends the communication range of units and devices included in the network as more DTUs are integrated into the mesh network 312. Similar to system 200, the mesh network 312 shown in FIG. 3 may also be implemented without the use of the gateway device 322.

Similar to the systems 100 and 150 of FIGS. 1A-1B and the system of FIG. 2, the DTUs shown in the system 300 may be configured to translate messages from one communication protocol to another communication protocol (for example, translate a message from an EcoNet protocol to a Thread protocol (or any other mesh network protocol) and/or any other type of translations between any other two communication protocols. This translation may be performed, for example, by using a look-up table, however, the translations may also be performed in any other suitable manner.

Also similar to systems 100 and 150, within the mesh network 312, any communications received by a DTU from a water heater unit may be transmitted to the gateway device 322 and the gateway device 322 may then transmit the communications to any number of different remote devices. For example, as shown in FIG. 3, the gateway device 322 may transmit the communications to one or more user devices 328, one or more cloud devices 330 (for example, a remote server), a BMS 332, and/or any other type of remote device.

The communications that are transmitted to the remote devices may also be transmitted using different communication protocols than the communication protocols used within the mesh network 312 and the communication protocols used between the water heater units and the DTUs. For example, FIG. 3 shows that the user devices 328 communicate with the gateway device 322 using Wi-Fi or Bluetooth communications, the cloud device 330 communicates with the gateway device 322 using Ethernet, and the BMS 332 communicates with the gateway device 322 using a BACnet communication protocol. These are merely exemplary communication protocols and any other communication protocols may be used. Accordingly, similar to the DTUs, the gateway device 322 may also be configured to perform translations between different types of communication protocols. Such communications may also be performed using a look-up table or using any other suitable method.

Referring now to FIGS. 4A-4C, components that may be included in a connectivity device 400 (which may be the same as connectivity device 306, connectivity device 316, etc.) are described in further detail. Although reference is made in FIGS. 4A-4C to water heater units, this is merely for consistency with FIG. 3 and any other types of units including any other types of sensors may also be applicable (thus, any reference in FIGS. 4A-4C to water heater units may also be replaced by the HVAC units of any of system 100, 150, 200, etc., and/or other types of units). Further, although reference is made to elements of system 300, this is merely for exemplary purposes and the same description of the connectivity devices may apply to any other system described herein or otherwise.

Beginning with FIG. 4A, connectivity device 400 may include one or more processors 402, communication module 404, and memory 406. As described above with respect to FIG. 3, communication module 404 allows connectivity device 400 to communicate with any DTUs within the mesh network 312. Communication module 404 may use any of various communication formats, such as, for example, an Internet communications format, or a cellular communications format.

Memory 406, which is one example of a non-transitory computer-readable medium, may be used to store operating system (OS) 408, sensors interface module 410, internal operations determination module 412, non-communicating device interface module 414, communicating device interface module 416, and thermostat interface module 418. The modules are provided in the form of computer-executable instructions that may be executed by processor 402 for performing various operations in accordance with the disclosure. Memory 406 may include any one memory element or a combination of volatile memory elements (e.g., random access memory (RAM), such as DRAM, SRAM, SDRAM, etc.) and non-volatile memory elements (e.g., ROM, hard drive, tape, CDROM, etc.). In the context of this document, a “non-transitory computer-readable medium” may be, for example but not limited to, an electronic, magnetic, optical, electromagnetic, infrared, or semiconductor system, apparatus, or device.

Sensors interface module 410 may be executed by processor 402 for receiving and processing data measured by the one or more sensors of connectivity device 400 operatively coupled to water heater unit 302, water heater unit 314, etc. For example, sensors interface module 410 may receive and process data indicative of at least one of a current associated with any of the water heater units from one or more current sensors, pressure associated with the water heater units from one or more pressure sensors, temperature associated with any of the water heater units from one or more temperature sensors, and/or any other types of data from any other types of sensors.

Internal operations determination module 412 may be executed by processor 402 for analyzing the data obtained and processed by sensors interface module 410 to determine the state of internal operations of the water heater units, e.g., the real-time operating conditions of the water heater units based on at least one of current, pressure, temperature, vibration, noise, etc. associated with water heater units. For example, based on the current data, internal operations determination module 412 may determine the amount of current that water heater unit 302 or 314 consumes, and compare it with a baseline and/or predetermined threshold amount associated with the baseline stored in memory 406 to determine if water heater unit 302 or 314 is drawing less or more current than under normal and/or tolerable operating conditions. For example, if internal wires are broken, the current data would indicate that water heater unit 302 or 314 is drawing zero current. This is merely one example of a type of data that may be analyzed and any other types of data from any other sensors may also be analyzed.

Non-communicating device interface module 414 may be executed by processor 402 for communicating data between connectivity device 400 and the non-communicating unit of system 300 that connectivity device 400 is coupled to, e.g., water heater unit 302 or 314. For example, non-communicating device interface module 414 may transmit commands to water heater unit 302 or 314, e.g., to cause water heater unit 302 or 314 to turn on or off and/or to operate until a temperature set point is achieved, responsive to user input. Moreover, non-communicating device interface module 414 may optimize the operation of water heater unit 302 or 314 by taking into account internal operation parameters of water heater unit 302 or 314 as determined by internal operations determination module 412. For example, if a potential issue is identified by internal operations determination module 412, e.g., based on one or more of current, pressure, temperature, vibration, or audio measurements associated with water heater unit 302 or 314, non-communicating device interface module 414 may adjust the operating parameters of water heater unit 302 or 314, and/or cause water heater unit 302 or 314 to power off until the potential issue is resolved. Moreover, based on known operational characteristics of water heater unit 302 or 314, internal operations determination module 412 may cause water heater unit 302 or 314 to operate in a manner such that the temperature set point is achieved in an energy efficient manner.

Communicating device interface module 416 may be executed by processor 402 for communicating data between connectivity device 400 and a communicating unit of system 300, e.g., first DTU 310, second DTU 320, etc. For example, communicating device interface module 416 may receive information indicative of the capabilities and/or internal operations parameters of water heater unit 302 or 314 and/or any other types of data from the water heater unit 302 or 314 and may transmit this data to any of the DTUs. The communicating device interface module 416 may also receive communications from any of the DTUs, such as command instructions for operations to be performed by the water heater unit 302 or 314. The command instructions may originate from a remote device, such as user device 328, cloud device 330, BMS 332, etc.

Thermostat interface module 418 may be executed by processor 402 for communicating data between connectivity device 400 and a thermostat. While communications including command instructions may be received from remote devices via a mesh network of DTUs, the water heater units may also be configured to communicate with and receive command instructions from a thermostat or like device as well.

It should be noted that while various modules are shown in the connectivity device 400 of FIG. 4A (as well as connectivity devices 430 and 460 of FIGS. 4B-4C), these modules are merely exemplary. In some instances, not all of the modules may be required. For example, the connectivity device 400 may also only include the sensor interface module 410 and the non-communicating device interface module 414.

Referring now to FIG. 4B, components that may be included in connectivity device 430 are described in further detail. As described above, connectivity device 430 may be constructed similar to connectivity device 400. For example, connectivity device 430 may include one or more processors 432, communication module 434, and memory 436, which correspond with one or more processors 402, communication module 404, and memory 406. Accordingly, communication module 434 allows wireless connectivity platform 430 to communicate with any water heater units of FIG. 3. Moreover, like memory 406, memory 436 may be used to store operating system (OS) 438, sensors interface module 440, internal operations determination module 442, non-communicating device interface module 444, and communicating device interface module 446. As water heater units are the communicating unit in system 300, communicating device interface module 446 may communicate with water heater units 302 and/or 314.

Unlike memory 406, memory 436 may include mobile application interface module 448 instead of thermostat interface module 418. That is, while communications including command instructions may be received from remote devices via a mesh network of DTUs, the water heater units may also be configured to communicate with and receive command instructions from a mobile device (the term “mobile device” is used interchangeably with user device herein), such as a smartphone, desktop computer, laptop computer, etc. Additionally, in some embodiments, a connectivity device may include both thermostat interface and mobile application interface modules. That is, a connectivity device may be configured to communicate with any of: the mesh network of DTUs, a mobile device, or a thermostat.

Referring now to FIG. 4C, components that may be included in connectivity device 460 are described in further detail. As described above, connectivity device 460 may be constructed similarly to connectivity device 400, 430. For example, connectivity device 460 may include one or more processors 462, communication module 464, and memory 466, which correspond with one or more processors 402, 432, communication module 404, 434, and memory 406, 406. Accordingly, communication module 464 allows wireless connectivity platform 460 to communicate with another connectivity device (for example, connectivity device 306 and connectivity device 316 in FIG. 3 may communicate. Moreover, like memory 406, memory 466 may store operating system (OS) 468, sensors interface module 470, internal operations determination module 472, and non-communicating device interface module 474.

Sensors interface module 470 and internal operations determination module 472 of the connectivity device coupled to water heater units 302 or 314 may operate in a similar manner to sensors interface module 440 and internal operations determination module 442, respectively, of connectivity device 430 coupled to water heater units 302 or 314. Unlike memory 406, 436, memory 466 may include connectivity device interface module 466 instead of communicating device interface module 416, 446. Connectivity device interface module 466 may be executed by processor 462 for communicating data between one connectivity device and another connectivity device within system 500. The connectivity device interface module 476 may also be included in any of the other connectivity devices as well.

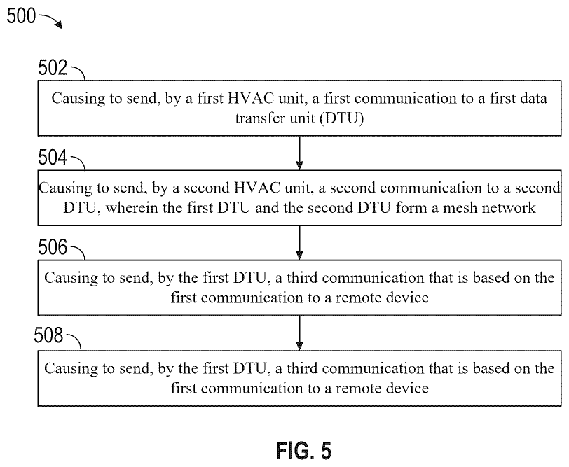

Referring now to FIG. 5, an example method 500 for providing wireless connectivity to HVAC systems is shown. Some or all of the blocks of the process flows or methods in this disclosure may be performed in a distributed manner across any number of devices or systems (for example, any of the devices and/or systems of systems 100, 150, 200, 300, etc.). The operations of the method 500 may be optional and may be performed in a different order.

At block 502 of the method 500, computer-executable instructions stored on a memory of a system or device may be executed to cause to send, by a first HVAC unit (for example, any of the HVAC units of the systems 100, 150, 200, etc., as well as any other types of units, such as the water heater units of system 300), a first communication to a first data transfer unit (DTU) (for example, any of the DTUs of systems 100, 150, 200, 300, etc.). The first communication may be sent using a first communication protocol, such as EcoNet, for example. The first communication may include status information about the first HVAC unit, such as data captured from one or more sensors of the first HVAC unit (such that a user may remotely view such data or an automated system, such as a BMS may receive the data). Likewise, communications may be transmitted from the first DTU to the first HVAC unit (that is, the communications may be bi-directional). For example, the first DTU may transmit a control command from a user device of the user or the BMS to the first HVAC unit.

At block 504 of the method 500, computer-executable instructions stored on a memory of a system or device may be executed to cause to send, by a second HVAC unit (for example, any of the HVAC units of the systems 100, 150, 200, etc., as well as any other types of units, such as the water heater units of system 300), a second communication to a second DTU (for example, any of the DTUs of systems 100, 150, 200, 300, etc.), wherein the first DTU and the second DTU form a mesh network (for example, mesh networks 115, 217, 312, and/or any other mesh networks). That is, each of the first HVAC unit and second HVAC unit may communicate with a respective DTU. However, as aforementioned, a system may also include a DTU or DTUs that communicate with multiple HVAC units, etc.

At block 506 of the method 500, computer-executable instructions stored on a memory of a system or device may be executed to cause to send, by the first DTU, a third communication that is based on the first communication to a remote device. That is, the first DTU may transmit the communication from the first HVAC unit using a different communication protocol to a remote device (for example, the user devices 128, cloud devices 130, BMS 132 of the system 100, as well as any other types of remote devices described herein or otherwise).

At block 508 of the method 500, computer-executable instructions stored on a memory of a system or device may be executed to cause to send, by the second DTU, a fourth communication that is based on the second communication to the remote device. That is, the first DTU may receive data from the first HVAC unit and may cause the data to be transmitted to the remote device and the second DTU may receive data from the second HVAC unit and may cause the data to be transmitted to the remote device. In some embodiments (such as systems 100, 150, 300, etc.), a dedicated gateway device may be provided. The DTUs may transmit the communications to the gateway device via the mesh network and the gateway device may transmit the data to the HVAC units. In other embodiments, the mesh network may only include the DTUs and the communications may be performed directly between a DTU and the remote device.

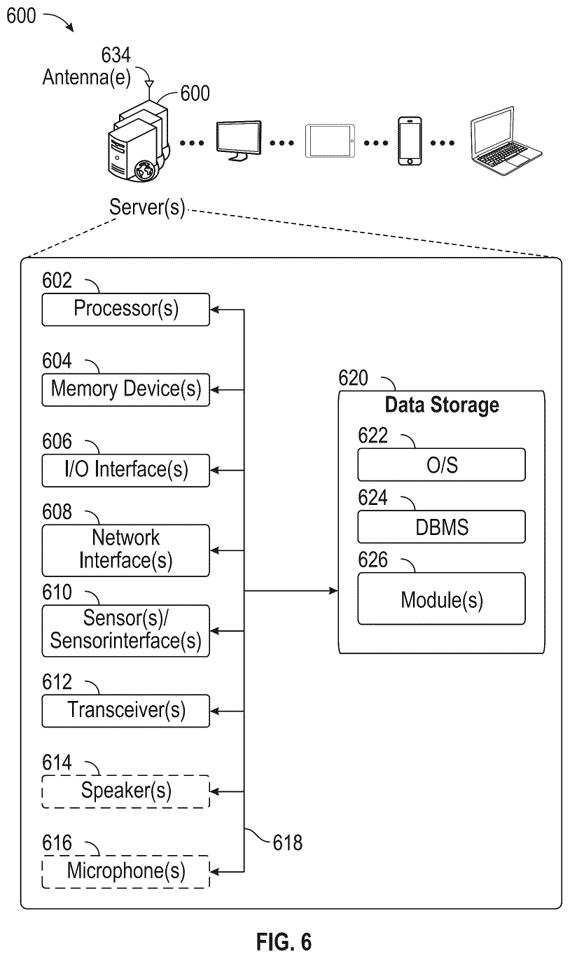

Referring now to FIG. 6, a schematic block diagram of one or more illustrative computing device(s) 600 is shown. The computing device(s) 600 may include any suitable computing device including, but not limited to, a server system, a mobile device such as a smartphone, a tablet, an e-reader, a wearable device, or the like; a desktop computer; a laptop computer; or the like. The computing device(s) 600 may correspond to an illustrative device configuration for any of the devices (e.g., any of the DTUs, gateway devices, thermostats, etc.). Additionally, although not specifically illustrated in the systems of FIGS. 1A-1B and 2-3, some or all of the HVAC units, water heaters, etc. may include one or more controllers configured to facilitate communications with other devices, cause units to perform functions, etc. (and these controllers may include elements of the computing device 600).

The computing device(s) 600 may be configured to communicate via one or more networks. Such network(s) may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the computing device(s) 600 may include one or more processors (processor(s)) 602, one or more memory devices 604 (generically referred to herein as memory 604), one or more input/output (I/O) interfaces 606, one or more network interfaces 608, one or more sensors or sensor interfaces 610, one or more transceivers 612, one or more optional speakers 614, one or more optional microphones 616, and data storage 620. The computing device(s) 600 may further include one or more buses 618 that functionally couple various components of the computing device(s) 600. The computing device(s) 600 may further include one or more antenna(e) 634 that may include, without limitation, a cellular antenna for transmitting or receiving signals to/from a cellular network infrastructure, an antenna for transmitting or receiving WiFi signals to/from an access point (AP), a Global Navigation Satellite System (GNSS) antenna for receiving GNSS signals from a GNSS satellite, a Bluetooth antenna for transmitting or receiving Bluetooth signals, a Near Field Communication (NFC) antenna for transmitting or receiving NFC signals, and so forth. These various components will be described in more detail hereinafter.

The bus(es) 618 may include at least one of a system bus, a memory bus, an address bus, or a message bus, and may permit the exchange of information (e.g., data (including computer-executable code), signaling, etc.) between various components of the computing device(s) 600. The bus(es) 618 may include, without limitation, a memory bus or a memory controller, a peripheral bus, an accelerated graphics port, and so forth. The bus(es) 618 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnect (PCI) architecture, a PCI-Express architecture, a Personal Computer Memory Card International Association (PCMCIA) architecture, a Universal Serial Bus (USB) architecture, and so forth.

The memory 604 of the computing device(s) 600 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 604 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 604 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 620 may include removable storage and/or non-removable storage, including, but not limited to, magnetic storage, optical disk storage, and/or tape storage. The data storage 620 may provide non-volatile storage of computer-executable instructions and other data. The memory 604 and the data storage 620, removable and/or non-removable, are examples of computer-readable storage media (CRSM) as that term is used herein.

The data storage 620 may store computer-executable code, instructions, or the like that may be loadable into the memory 604 and executable by the processor(s) 602 to cause the processor(s) 602 to perform or initiate various operations. The data storage 620 may additionally store data that may be copied to the memory 604 for use by the processor(s) 602 during the execution of the computer-executable instructions. Moreover, output data generated as a result of execution of the computer-executable instructions by the processor(s) 602 may be stored initially in the memory 604, and may ultimately be copied to the data storage 620 for non-volatile storage.

More specifically, the data storage 620 may store one or more operating systems (O/S) 622; one or more database management systems (DBMSs) 624; and one or more program module(s), applications, engines, computer-executable code, scripts, or the like such as, for example, one or more data management module(s) 626, one or more data analysis module(s) 628, and/or one or more OBD module(s) 630. Some or all of these module(s) may be sub-module(s). Any of the components depicted as being stored in the data storage 620 may include any combination of software, firmware, and/or hardware. The software and/or firmware may include computer-executable code, instructions, or the like that may be loaded into the memory 604 for execution by one or more of the processor(s) 602. Any of the components depicted as being stored in the data storage 620 may support functionality described in reference to corresponding components named earlier in this disclosure.

The data storage 620 may further store various types of data utilized by the components of the computing device(s) 600. Any data stored in the data storage 620 may be loaded into the memory 604 for use by the processor(s) 602 in executing computer-executable code. In addition, any data depicted as being stored in the data storage 620 may potentially be stored in one or more datastore(s) and may be accessed via the DBMS 624 and loaded in the memory 604 for use by the processor(s) 602 in executing computer-executable code. The datastore(s) may include, but are not limited to, databases (e.g., relational, object-oriented, etc.), file systems, flat files, distributed datastores in which data is stored on more than one node of a computer network, peer-to-peer network datastores, or the like.

The processor(s) 602 may be configured to access the memory 604 and execute the computer-executable instructions loaded therein. For example, the processor(s) 602 may be configured to execute the computer-executable instructions of the various program module(s), applications, engines, or the like of the computing device(s) 600 to cause or facilitate various operations to be performed in accordance with one or more embodiments of the disclosure. The processor(s) 602 may include any suitable processing unit capable of accepting data as input, processing the input data in accordance with stored computer-executable instructions, and generating output data. The processor(s) 602 may include any type of suitable processing unit including, but not limited to, a central processing unit, a microprocessor, a reduced instruction set computer (RISC) microprocessor, a complex instruction set computer (CISC) microprocessor, a microcontroller, an application-specific integrated circuit (ASIC), a field-programmable gate array (FPGA), a system-on-a-chip (SoC), a digital signal processor (DSP), and so forth. Further, the processor(s) 602 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 602 may be capable of supporting any of a variety of instruction sets.

Referring now to functionality supported by the various program module(s) depicted in FIG. 6, the module(s) 626 may include computer-executable instructions, code, or the like that responsive to execution by one or more of the processor(s) 602 may perform any of the functions associated with providing wireless connectivity to HVAC systems (or any other types of systems/units) via a mesh network as described herein.

Referring now to other illustrative components depicted as being stored in the data storage 620, the O/S 622 may be loaded from the data storage 620 into the memory 604 and may provide an interface between other application software executing on the computing device(s) 600 and the hardware resources of the computing device(s) 600. More specifically, the O/S 622 may include a set of computer-executable instructions for managing hardware resources of the computing device(s) 600 and for providing common services to other application programs (e.g., managing memory allocation among various application programs). The O/S 622 may include any operating system now known or which may be developed in the future, including, but not limited to, any server operating system, any mainframe operating system, or any other proprietary or non-proprietary operating system.

The DBMS 624 may be loaded into the memory 604 and may support functionality for accessing, retrieving, storing, and/or manipulating data stored in the memory 604 and/or data stored in the data storage 620. The DBMS 624 may use any of a variety of database models (e.g., relational model, object model, etc.) and may support any of a variety of query languages. The DBMS 624 may access data represented in one or more data schemas and stored in any suitable data repository including, but not limited to, databases (e.g., relational, object-oriented, etc.), file systems, flat files, distributed datastores in which data is stored on more than one node of a computer network, peer-to-peer network datastores, or the like. In those example embodiments in which the computing device(s) 600 is a mobile device, the DBMS 624 may be any suitable lightweight DBMS optimized for performance on a mobile device.

Referring now to other illustrative components of the computing device(s) 600, the input/output (I/O) interface(s) 606 may facilitate the receipt of input information by the computing device(s) 600 from one or more I/O devices as well as the output of information from the computing device(s) 600 to one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the computing device(s) 600 or may be separate. The I/O devices may further include, for example, any number of peripheral devices such as data storage devices, printing devices, and so forth.

The I/O interface(s) 606 may also include an interface for an external peripheral device connection such as a universal serial bus (USB), FireWire, Thunderbolt, Ethernet port or other connection protocol that may connect to one or more networks. The I/O interface(s) 606 may also include a connection to one or more of the antenna(e) 634 to connect to one or more networks via a wireless local area network (WLAN) (such as WiFi) radio, Bluetooth, ZigBee, and/or a wireless network radio, such as a radio capable of communication with a wireless communication network such as a Long Term Evolution (LTE) network, WiMAX network, 3G network, etc.

The computing device(s) 600 may further include one or more network interface(s) 608 via which the computing device(s) 600 may communicate with any of a variety of other systems, platforms, networks, devices, and so forth. The network interface(s) 608 may enable communication, for example, with one or more wireless routers, one or more host servers, one or more web servers, and the like via one or more networks.

The antenna(e) 634 may include any suitable type of antenna depending, for example, on the communications protocols used to transmit or receive signals via the antenna(e) 634. Non-limiting examples of suitable antennae may include directional antennae, non-directional antennae, dipole antennae, folded dipole antennae, patch antennae, multiple-input multiple-output (MIMO) antennae, or the like. The antenna(e) 634 may be communicatively coupled to one or more transceivers 612 or radio components to which or from which signals may be transmitted or received.

As previously described, the antenna(e) 634 may include a cellular antenna configured to transmit or receive signals in accordance with established standards and protocols, such as Global System for Mobile Communications (GSM), 3G standards (e.g., Universal Mobile Telecommunications System (UMTS), Wideband Code Division Multiple Access (W-CDMA), CDMA2000, etc.), 4G standards (e.g., Long-Term Evolution (LTE), WiMax, etc.), direct satellite communications, or the like.

The antenna(e) 634 may additionally, or alternatively, include a WiFi antenna configured to transmit or receive signals in accordance with established standards and protocols, such as the IEEE 802.11 family of standards, including via 2.4 GHz channels (e.g., 802.11b, 802.11g, 802.11n), 5 GHz channels (e.g., 802.11n, 802.11ac), or 60 GHz channels (e.g., 802.11ad). In alternative example embodiments, the antenna(e) 634 may be configured to transmit or receive radio frequency signals within any suitable frequency range forming part of the unlicensed portion of the radio spectrum.

The antenna(e) 634 may additionally, or alternatively, include a GNSS antenna configured to receive GNSS signals from three or more GNSS satellites carrying time-position information to triangulate a position therefrom. Such a GNSS antenna may be configured to receive GNSS signals from any current or planned GNSS such as, for example, the Global Positioning System (GPS), the GLONASS System, the Compass Navigation System, the Galileo System, or the Indian Regional Navigational System.

The transceiver(s) 612 may include any suitable radio component(s) for—in cooperation with the antenna(e) 634—transmitting or receiving radio frequency (RF) signals in the bandwidth and/or channels corresponding to the communications protocols utilized by the computing device(s) 600 to communicate with other devices. The transceiver(s) 612 may include hardware, software, and/or firmware for modulating, transmitting, or receiving—potentially in cooperation with any of antenna(e) 634—communications signals according to any of the communications protocols discussed above including, but not limited to, one or more WiFi and/or WiFi direct protocols, as standardized by the IEEE 802.11 standards, one or more non-Wi-Fi protocols, or one or more cellular communications protocols or standards. The transceiver(s) 612 may further include hardware, firmware, or software for receiving GNSS signals. The transceiver(s) 612 may include any known receiver and baseband suitable for communicating via the communications protocols utilized by the computing device(s) 600. The transceiver(s) 612 may further include a low noise amplifier (LNA), additional signal amplifiers, an analog-to-digital (A/D) converter, one or more buffers, a digital baseband, or the like.

The sensor(s)/sensor interface(s) 610 may include or may be capable of interfacing with any suitable type of sensing device such as, for example, inertial sensors, force sensors, thermal sensors, and so forth. Example types of inertial sensors may include accelerometers (e.g., MEMS-based accelerometers), gyroscopes, and so forth.

The speaker(s) 614 may be any device configured to generate audible sound. The microphone(s) 616 may be any device configured to receive analog sound input or voice data.

It should be appreciated that the program module(s), applications, computer-executable instructions, code, or the like depicted in FIG. 6 as being stored in the data storage 620 are merely illustrative and not exhaustive and that processing described as being supported by any particular module may alternatively be distributed across multiple module(s) or performed by a different module. In addition, various program module(s), script(s), plug-in(s), application programming interface(s) (API(s)), or any other suitable computer-executable code hosted locally on the computing device(s) 600, and/or hosted on other computing device(s) accessible via one or more networks, may be provided to support functionality provided by the program module(s), applications, or computer-executable code depicted in FIG. 6 and/or additional or alternate functionality. Further, functionality may be modularized differently such that processing described as being supported collectively by the collection of program module(s) depicted in FIG. 6 may be performed by a fewer or greater number of module(s), or functionality described as being supported by any particular module may be supported, at least in part, by another module. In addition, program module(s) that support the functionality described herein may form part of one or more applications executable across any number of systems or devices in accordance with any suitable computing model such as, for example, a client-server model, a peer-to-peer model, and so forth. In addition, any of the functionality described as being supported by any of the program module(s) depicted in FIG. 6 may be implemented, at least partially, in hardware and/or firmware across any number of devices.

It should further be appreciated that the computing device(s) 600 may include alternate and/or additional hardware, software, or firmware components beyond those described or depicted without departing from the scope of the disclosure. More particularly, it should be appreciated that software, firmware, or hardware components depicted as forming part of the computing device(s) 600 are merely illustrative and that some components may not be present or additional components may be provided in various embodiments. While various illustrative program module(s) have been depicted and described as software module(s) stored in the data storage 620, it should be appreciated that functionality described as being supported by the program module(s) may be enabled by any combination of hardware, software, and/or firmware. It should further be appreciated that each of the above-mentioned module(s) may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other module(s). Further, one or more depicted module(s) may not be present in certain embodiments, while in other embodiments, additional module(s) not depicted may be present and may support at least a portion of the described functionality and/or additional functionality. Moreover, while certain module(s) may be depicted and described as sub-module(s) of another module, in certain embodiments, such module(s) may be provided as independent module(s) or as sub-module(s) of other module(s).

One or more operations of the methods, process flows, and use cases of FIGS. 1-3 may be performed by a device having the illustrative configuration depicted in FIG. 6, or more specifically, by one or more engines, program module(s), applications, or the like executable on such a device. It should be appreciated, however, that such operations may be implemented in connection with numerous other device configurations.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Program module(s), applications, or the like disclosed herein may include one or more software components, including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component including assembly language instructions may require conversion into executable machine code by an assembler prior to execution by the hardware architecture and/or platform.

Another example programming language may be a higher-level programming language that may be portable across multiple architectures. A software component including higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component including instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may include other custom-developed application software, operating system functionality (e.g., device drivers, data storage (e.g., file management) routines, other common routines, and services, etc.), or third party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program module(s), or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

We claim:

1. A heating, ventilation, and air conditioning (HVAC) system comprising:
a first HVAC unit and a second HVAC unit;
a first data transfer unit (DTU) in wireless or wired communication with the first HVAC unit and a second DTU in wireless or wired communication with the second HVAC unit,
wherein the first DTU and the second DTU form a mesh network; and
a remote device configured to receive communications from the first HVAC unit and the second HVAC unit via the mesh network.

2. The HVAC system of claim 1, wherein the first HVAC unit and second HVAC unit communicate with the first DTU and the second DTU using a first communication protocol, and wherein the first DTU and second DTU communicate within the mesh network using a second communication protocol.

3. The HVAC system of claim 2, wherein the first DTU and second DTU communicate with the remote device using a third communication protocol.

4. The HVAC system of claim 2, wherein the first DTU and second DTU further comprise one or more processors configured to translate a message from the first communication protocol to the second communication protocol.

5. The HVAC system of claim 4, wherein the translation is performed using a look-up table.

6. The HVAC system of claim 1, further comprising a gateway device in communication with the first DTU and the second DTU via the mesh network.

7. The HVAC system of claim 6, wherein the gateway device communicates with the remote device using a third communication protocol.

8. The HVAC system of claim 1, wherein the remote device communicates directly with at least one of the first DTU or the second DTU without a gateway device.

9. A method comprising:
causing to send, by a first HVAC unit, a first communication to a first data transfer unit (DTU);
causing to send, by a second HVAC unit, a second communication to a second DTU, wherein the first DTU and the second DTU form a mesh network;
causing to send, by the first DTU, a third communication that is based on the first communication to a remote device; and
causing to send, by the second DTU, a fourth communication that is based on the second communication to the remote device.

10. The method of claim 9, wherein the first communication and the second communication are performed using a first communication protocol, and wherein the first DTU and second DTU are configured to communicate using a second communication protocol.

11. The method of claim 10, wherein the third communication and fourth communication are performed with the remote device using a third communication protocol.

12. The method of claim 10, further comprising:
translating, by the first DTU or the second DTU, a message from the first communication protocol to the second communication protocol.

13. The method of claim 12, wherein the translation is performed using a look-up table.

14. The method of claim 9, further comprising:
receiving, by a gateway device, the third communication and the fourth communication; and
sending, by the gateway device, a fifth communication based on the third communication and a sixth communication based on the fourth communication to the remote device.

15. The method of claim 14, wherein the fifth communication and the sixth communication are performed using a third communication protocol.

16. The method of claim 9, wherein the third communication and the fourth communication are sent directly to the remote device without a gateway device.

17. A system comprising:
a first non-communicating appliance and a second non-communicating appliance;
a first connectivity device associated with the first non-communicating appliance and a second connectivity device associated with the second non-communicating appliance;
a first data transfer unit (DTU) in communication with the first connectivity device and a second DTU in communication with the second connectivity device,
wherein the first DTU and the second DTU form a mesh network; and
a remote device configured to receive communications from the first connectivity device and the second connectivity device via the mesh network.

18. The system of claim 17, wherein the first non-communicating appliance and second non-communicating appliance communicate with the first DTU and the second DTU using a first communication protocol, and wherein the first DTU and second DTU communicate using a second communication protocol.

19. The system of claim 18, wherein the first DTU and second DTU communicate with the remote device using a third communication protocol.

20. The system of claim 17, further comprising a gateway device in communication with the first DTU and the second DTU via the mesh network.
